(19) United States
(12) Patent Application Publication
(10) Pub. No.: US 2011/0317158 A1
(43) Pub. Date: Dec. 29, 2011

(54) CYTOLOGICAL METHOD FOR ANALYZING A BIOLOGICAL SAMPLE BY RAMAN SPECTROSCOPY

(76) Inventors: Fiona M. Lyng, Dublin (IE); Hugh Byrne, Dublin (IE); Eoghan O Faolain, Dublin (IE); Colin Clarke, Dublin (IE); Kamila Ostrowska, Dublin (IE)

(21) Appl. No.: 13/164,667

(22) Filed: Jun. 20, 2011

Related U.S. Application Data
(63) Continuation-in-part of application No. PCT/EP2009/067595, filed on Dec. 18, 2009.

(30) Foreign Application Priority Data
Dec. 18, 2008 (GB) 0823071.6

(51) Int. Cl. G01J 3/44

(52) U.S. Cl. 356/301

(57) ABSTRACT

Provided herein are systems and methods that permit low resolution Raman spectroscopy to be used for detection of biological components within cells in order to classify the cells, for example, as premalignant, malignant, or benign.

### RELATED APPLICATIONS

This application is a continuation-in-part of International Application Number PCT/EP2009/067595, filed Dec. 18, 2009, which claims priority from GB 0823071.6, filed Dec. 18, 2008, both of which are hereby incorporated herein in their entireties.

### FIELD OF THE INVENTION

Aspects of the invention relate to cytological analyses using low resolution Raman spectroscopy.

### BACKGROUND

Cancer is a class of diseases in which a group of cells displays uncontrolled growth and is responsible for approximately 13% of all deaths. Significant research has been conducted in the area of diagnosis because early detection of cancer leads to improved survival rates and less drastic treatments.

For cervical cancer, the second deadliest cancer in women, a currently used screening method is a smear test (a Papanicolaou smear, or Pap smear). In a smear test, cell/tissue samples are collected from the outer opening of the cervix using, for example, a spatula or brush. The cells are then stained and visually inspected for abnormalities by light microscopy. Smear tests are subjective and prone to sampling errors, and both false negative and false positive readings of the sample are common.

### SUMMARY OF THE INVENTION

Certain aspects provided herein relate to systems and methods that permit low resolution Raman spectroscopy (LRRS) to be used for detection of biological components within cells (e.g., cervical cells) in order to classify the cells, for example, as premalignant, malignant, or benign. Raman light scattering techniques (Raman spectroscopy) have been used in the past to detect specific chemical components in a variety of samples. Raman spectroscopy is a spectroscopic technique (vibrational spectroscopy) which relies on Raman scattering by a sample of monochromatic light from a laser. Raman scattering is a basic property of the interaction of light with molecules; however, Raman scattering is not simply a direct alternative to other techniques, such as InfraRed (IR) spectroscopy. Spectral peaks (or bands) that are typically Raman active are usually IR weak and vice versa.

When light hits a molecule it can cause the atoms of the molecule to vibrate. The difference in energy between the incident light and the Raman scattered light is equal to the energy of a vibration of the scattering molecule. Thus, Raman spectra can be used to uniquely identify a molecule. Previously, high resolution Raman spectroscopy has been used to detect the presence of cellular biological components (Lyng, et al. Exp and Mol Pathology, 2007, 82:121-129, the entire disclosure of which is herein incorporated by reference); however, these high resolution analyses have required a high degree of technical knowledge and expensive, large/complex equipment.

In some embodiments, certain aspects of the invention relate to methods for classifying a cell/tissue sample using Raman spectroscopy, comprising: (a) performing Raman spectroscopy on a cell/tissue sample of unknown cell class and obtaining from the sample one or more low resolution sample spectra; (b) comparing the one or more low resolution sample spectra to a reference dataset comprising spectral peaks associated with at least one cell class; and (c) classifying the unknown cell/tissue sample as comprising one of the at least one cell class or not comprising the at least one cell class based on a determination of the similarity of spectral peaks of the one or more low resolution sample spectra and the spectral peaks in the reference dataset, wherein the resolution of the one or more low resolution sample spectra is at least (or greater than) 3 wavenumbers.

In certain embodiments, aspects of the invention relate to methods for classifying a cell/tissue sample using Raman spectroscopy, comprising: (a) performing Raman spectroscopy on a cervical cell/tissue sample of unknown cell class and obtaining from the sample one or more low resolution sample spectra; (b) comparing the one or more low resolution sample spectra to a reference dataset comprising spectral peaks associated with at least one cell class; and (c) classifying the unknown cell/tissue sample as comprising one of the at least one cell class or not comprising the at least one cell class based on a determination of the similarity of spectral peaks of the one or more low resolution sample spectra and the spectral peaks in the reference dataset, wherein the resolution of the one or more low resolution sample spectra is at least (or greater than) 3 wavenumbers.

In some embodiments, aspects of the invention relate to methods for classifying a cell/tissue sample using Raman spectroscopy, comprising: (a) generating from cell/tissue samples of at least one known cell class a reference dataset of low resolution Raman spectral peaks characteristic of the at least one known cell class; (b) providing the reference dataset to facilitate comparing one or more low resolution sample spectra obtained from a cell/tissue sample of unknown cell class to the spectral peaks of the reference dataset and assigning the unknown cell/tissue sample to a cell class based on the comparison, wherein the resolution of the spectral peaks in the reference dataset and the resolution of the sample spectra is at least (or greater than) 3 wavenumbers.

In certain embodiments, aspects of the invention relate to methods for classifying a cell/tissue sample using Raman spectroscopy, comprising: (a) generating from cell/tissue samples of at least one known cell class a reference dataset of low resolution Raman spectral peaks characteristic of the at least one known cell class; (b) generating a pattern recognition model/algorithm using the reference dataset of (a); and (c) implementing the pattern recognition model to assign a cell class to an unknown cell/tissue sample based on one or more low resolution Raman spectra acquired from the unknown cell/tissue sample, wherein the resolution of the spectral peaks in the reference dataset and the resolution of the sample spectra is greater than 3 wavenumbers.

In any one of the foregoing embodiments, the unknown cell/tissue sample is gynecological, breast, urological, renal, digestive, thyroid, or lymph node cell/tissue. In some embodiments, the gynecological tissue is vaginal, cervical, ovarian, or uterine tissue. In particular embodiments, the gynecological tissue is cervical tissue.

In any one of the foregoing embodiments, the reference dataset may comprise spectral peaks acquired from normal and abnormal cell/tissue samples. In some embodiments, the spectral peaks acquired from the abnormal cell/tissue samples represent a premalignant cell class, a malignant cell class, or a combination thereof. In some embodiments, the unknown cell/tissue sample is classified as normal or abnormal. In particular embodiments, the abnormal cell class is premalignant or malignant.

In certain embodiments, the reference dataset comprises spectral peaks acquired from normal, carcinoma, cervical intraepithelial neoplasia (CIN) I, CIN II, or CIN III cell/tissue samples. In some embodiments, the spectral peaks represent glycogen. In some embodiments, the low resolution spectral peaks are at approximately 480 cm⁻¹, 850 cm⁻¹, and 950 cm⁻¹.

In any of the foregoing embodiments, the resolution of the spectral peaks in the reference dataset may be at least (or greater than) 3 wavenumbers.

In any of the foregoing embodiments, the low resolution spectral peaks may represent nucleic acids at approximately 720 cm⁻¹, 780 cm⁻¹, and 1580 cm⁻¹.

In any of the foregoing embodiments, the specificity of the classifying may be greater than (or equal to) approximately 95%. In any of the foregoing embodiments, the sensitivity of the classifying may be greater than (or equal to) approximately 95%.

In certain embodiments, the generating of the reference dataset comprises performing at least one unsupervised multivariate analysis of the known cell/tissue sample spectra. In some embodiments, the at least one unsupervised multivariate analysis is principal component analysis (PCA).

In some embodiments, the pattern recognition model/algorithm is a support vector machine (SVM) or an artificial neural network (ANN).

In some embodiments, the generating of the pattern recognition model/algorithm comprises training the model/algorithm. In certain embodiments, the model/algorithm is training using a mathematical computer software program.

In some embodiments, the specificity of the assigning is greater than approximately 95%. In some embodiments, the sensitivity of the assigning is greater than approximately 95%.

In certain embodiments, aspects of the invention relate to Raman spectroscopy systems, comprising: (a) a low resolution Raman spectrometer having a spectral resolution of greater than 3 wavenumbers; and (b) an analysis module configured with a pattern recognition model/algorithm trained to compare one or more low resolution Raman sample spectrum acquired from cell/tissue sample of unknown cell class to spectral peaks of a reference dataset of Raman spectral peaks characteristic of at least one known cell class, and further configured to assign the cell/tissue sample to a cell class based on the comparison.

In some embodiments, the system further comprises an optical microscope, an optical light source, a stage for receiving a cell/tissue sample, a controller, and/or a display. In certain embodiments, the display is configured with a graphical user interface.

In certain embodiments, aspects of the invention relate to software products comprising a computer readable file encoding a sequence of software instructions which, when executed, direct performance of a method of analyzing Raman spectra comprising: comparing one or more low resolution sample spectra acquired from a cell/tissue sample of unknown cell class with a Raman spectrometer having a spectral resolution of greater than 3 wavenumbers to spectral peaks of a reference dataset of Raman spectral peaks characteristic of at least one known cell class; and assigning the test sample to a class based on the comparison.

In some embodiments, the computer readable file encodes a mathematical pattern recognition model/algorithm. In some embodiments, the pattern recognition model/algorithm is a support vector machine (SVM) or an artificial neural network (ANN).

In some embodiments, aspects of the invention relate to cytological methods for analyzing a biological sample, the method comprising the steps of: (a) consolidating a biological sample into a mass; (b) obtaining a Raman spectrum for the mass; and (c) comparing the Raman spectrum of the mass with one or more reference spectra, each of the reference spectra corresponding to a known abnormality to determine whether the contents of the mass contain one of the known abnormalities.

In yet other embodiments, aspects of the invention relate to cytology systems for analyzing a biological sample on a sample holder, optionally a slide, the system comprising a stage for receiving the sample holder, a low resolution Raman spectroscopy device having a spectral resolution worse than (greater than) 3 wavenumbers, the Raman spectroscopy device having an analysis module for determining whether the spectrum falls within one or more predefined classes of cell.

### BRIEF DESCRIPTION OF THE DRAWINGS

FIG. 1 is a schematic diagram that illustrates one embodiment of a low resolution Raman spectroscopy system described herein.

FIG. 2 is an outline of how a classification algorithm is created using the low resolution Raman spectroscopy system provided herein.

FIG. 3A depicts Raman spectra for normal cervical tissue at low resolution (top) and high resolution (bottom). The main biological peaks (see Table I) are resolved at low resolution including the normal markers (#1) 480 cm⁻¹, (#2) 850 cm⁻¹, and (#3) 950 cm⁻¹.

FIG. 3B depicts Raman spectra for abnormal cervical tissue at low resolution (top) and high resolution (bottom). The main biological peaks (see Table I) are resolved at low resolution including the tumor markers (#1) 720 cm⁻¹, (#2) 780 cm⁻¹, and (#3) 1580 cm⁻¹.

FIG. 4 is a scatter plot illustrating multivariate analysis (principal component analysis (PCA)) of data in FIGS. 3A and 3B, showing differentiation between normal epithelial tissue (class 1), invasive carcinoma (class 2), and cervical intraepithelial neoplasia (CIN) tissue (class 3).

FIG. 5A depicts Raman spectra for a normal cervical smear sample at low resolution (top) and high resolution (bottom). The main biological peaks (see table I) are resolved at low resolution.

FIG. 5B depicts Raman spectra for an abnormal CIN smear sample at low resolution (top) and high resolution (bottom). The main biological peaks (see table I) are resolved at low resolution.

FIG. 6 is a 3-axis scatter plot illustrating normal (negative), negative/reactive changes, inflammation, borderline nuclear abnormalities from the same CIN III smear samples used in for acquisition of the Raman spectra FIGS. 5A and 5B.

FIG. 7 is a screen shot that depicts an example of a graphical interface of an exemplary Raman system of the invention for use in selecting in a cell/tissue sample an area for acquisition of spectrum by a Raman microscope of the system.

### DETAILED DESCRIPTION OF THE INVENTION

Presented herein are cytology methods and systems and software products for employing the methods using low-resolution Raman spectroscopy, a spectroscopic technique (vibrational spectroscopy) which relies on Raman scattering by a sample of monochromatic light from a laser. In Raman scattering, a defined amount of energy is transferred from the photons to the molecules in which a vibrational mode is excited. The exact energy required to excite a molecular vibration depends on the masses of the atoms involved in the vibration and the type of chemical bonds between these atoms. This energy requirement may be influenced by the molecular structure, the molecular interactions, and the chemical microenvironment of the molecule. The positions, relative intensities, and shapes of the spectral bands carry detailed information about the molecular composition of the sample, and may be used to distinguish differences between normal and diseased cells/tissue. Raman peak position and assignments of main Raman vibrational modes are presented in Table I.

TABLE I
Peak position and assignments of main Raman vibrational modes

| Wavenumbers (cm⁻¹) | Raman peak assignments |
|---|---|
| 480 | Glycogen |
| 621 | C-C twisting mode of Phenylalanine |
| | (Protein) |
| 642-5 | C-C twisting mode of Tyrosine and |
| | Phenylalanine |
| 670-7 | C, T, G (DNA/RNA) |
| 717 | CN⁺(CH₃)₃ stretching in lipids |
| 729 | A (DNA/RNA) |
| 750-60 | Symmetric Breathing of Tryptophan |
| | (protein) |
| 782 | U, T, C (ring breathing modes in the |
| | DNA/RAN) |
| 788 | O—P—O Stretching in DNA |
| 811 | O—P—O Stretching in RNA |
| 827-8 | PO₂ Stretching in DNA, ring breathing in |
| | Tyrosine |
| 854 | Ring breathing in Tyrosine and Proline |
| | (protein) |
| 937 | C-C stretching mode (α helix) or Proline and |
| | Valine, CO₂ glycos |
| 980 | C-C stretching mode (β-sheet), ═CH bend of |
| | lipids |
| 1003-5 | C-C aromatic ring stretching in |
| | Phenylalanine |
| 1031 | C—H bending mode in Phenylalanine, C—N |
| | stretching in proteins. |
| 1060-95 | Symmetric PO₂ stretching of the DINA |
| | backbone; lipids; C-C stretch in |
| | carbohydrates |
| 1128 | C—N stretching in proteins; C—O stretching in |
| | carbohydrates |
| 1155 | C-C and C—N stretching of proteins |
| 1175-6 | C—H in plane bending mode of Tyrosine and |
| | Phenylalanine; C, G |
| 1208-9 | C—C₆H₅ stretching mode in Tryptophan, |
| | Phenylalanine |
| 1220-1284 | Amide III; A, C, T ring breathing modes of |
| | the DNA/RNA |
| 1301 | CH twist of lipids |
| 1311 | CH₃/CH₂ twisting mode of collagen and |
| | lipid |
| 1340-2 | G (DNA/RNA), CH deformation in proteins |
| | and carbohydrates; Tryptophan |
| 1420-1480 | G, A, CH deformation; C—H of Proteins, CH |
| | deformation of Lipids and carbohydrates. |
| 1450 | CH(CH₂) bending mode in proteins and |
| | lipids |
| 1583 | A, G (DNA/RNA); C═C bending mode of |
| | Phenylalanine |
| 1618 | C═C phenylalanine, Tyrosine and |
| | Tryptophan |
| 1550-1700 | H₂O bending mode |
| 1620-1700 | Amide I |
| 1736 | C═O ester (lipid) |

Low-resolution Raman spectroscopy has several advantages over high-resolution Raman spectroscopy, particularly when used in hospital settings, as low-resolution spectroscopy is lower in cost, the equipment may be smaller, less expensive/complex and optionally portable. When used together with a classification algorithm and a user friendly graphical user interface, its use may not require extensive specialized training. Provided herein are methods and systems for cytology sampling using Low Resolution Raman Spectroscopy (LRRS). Unexpectedly, Raman spectroscopy, even when used at low spectral resolution settings, may be used to distinguish among biological samples (e.g., cell and/or tissue samples) to classify the sample as, for example, premalignant, malignant, or benign. “Low resolution spectra”, or “low resolution sample spectra”, as used herein, refers to spectra having a spectral resolution of greater than (i.e., worse than) 3 wavenumbers. Wavenumbers, have units of inverse length. In order to convert between spectral wavelength and wavenumbers of shift in a Raman spectrum, the following formula can be used:

$$Δ w = ( \frac{1}{{λ}_{0}} - \frac{1}{{λ}_{1}} ) ,$$

where Δw is the Raman shift expressed in wavenumber, λ₀ is the excitation wavelength, and λ₁ is the Raman spectrum wavelength. The units for expressing wavenumber in Raman spectra may be inverse centimeters (cm⁻¹). Wavelength is often expressed in units of nanometers (nm), and the formula above can scale for this units conversion:

$$Δ w ( {cm}^{- 1} ) = ( \frac{1}{{λ}_{0} ( nm )} - \frac{1}{{λ}_{1} ( nm )} ) \times {10}^{7} \frac{( nm )}{( cm )} ,$$

In some embodiments, low resolution may refer to between about 3 to about 10 wavenumbers. In still other embodiments, low resolution may refer to 3, 4, 5, 6, 7, 8, 9, or 10 wavenumbers. It should be understood that spectral resolution, in some embodiments, may also be defined in terms of focal length, diffraction grating, laser wavelength, and pixel density, as described below.

In some embodiments, a low resolution spectra may have a spectral dispersion of approximately 3 to approximately 6 cm⁻¹/pixel. In particular embodiments, the spectral dispersion is approximately 3, 4, 5, or 6 cm⁻¹/pixel.

Certain embodiments described herein are directed to the use of low resolution Raman spectroscopy as a diagnostic tool to detect biochemical changes (e.g., abnormalities) accompanying cancer progression (e.g., in cervical or other cancers). Low resolution Raman spectra may be acquired or acquired from amino acids, proteins, dipeptides, purines (adenine and guanine), pyrimidines (cytosine and thymine), nucleic acids, carbohydrates, lipids (e.g., phosphatidylcholine and phosphatidylinositol), or other molecular components present in the samples, providing insight into the biochemical composition of cells and tissues. As the molecular complexity increases, spectral peaks broaden. For example, spectra acquired from amino acids show many narrow bands because of the relatively simple structure of the amino acids. By contrast, more complex proteins and carbohydrates show broader spectral features. In some embodiments, more than one spectra is acquired from a particular cell/tissue sample. For example, in some instances, 10 different spectra may be acquired from different focal areas (spots) within a single cell/tissue sample, each spot represented by a single spectra. In some embodiments about 2, 3, 4, 5, 6, 7, 8, 9, or 10 spectra are acquired from a single cell/tissue sample. In other embodiments, more than 10 spectra (from 10 different spots) are acquired from a single cell/tissue sample. The number of spectra used to classify a cell/tissue sample may depend on the size, the origin (type), or the biochemical composition of the cells/tissue. Larger, more complex tissues (e.g., comprised of a heterogenous cell population) may require more spectral sampling spots to permit accurate cell classification.

The location and number of spectral recordings within a single cell or tissue sample may be determined empirically. In certain embodiments, the spot or abnormality from which a spectral peak is acquired is visually perceptible. For example, the spot in the cell or tissue sample may be darker then the surrounding tissue or it may be irregular in shape (relative to surrounding cell or tissue components). In some embodiments, the visually abnormality may be an aberrant collection of cells or cell components. For example, tumor cells (benign or malignant) form a cell mass resulting from an increase in cell proliferation/ell division. In other embodiments, the abnormality is not visual perceptible. In certain embodiments, the abnormality is a chromosomal abnormality, for example, chromosomal number changes or aneuploidy. In other embodiments, the location and number of spectral recordings within a single cell or tissue sample may be random. A cell or tissue abnormality may not be visual, and in such instances, a random spectral sampling of the sample may be used to determine the class of the cell. In particular embodiments, a large number of spots (e.g., at least 10) are initially acquired from a cell/tissue sample to assess the homogeneity/reproducibility of the Raman spectra from different sampling spots.

Low resolution spectral peaks may represent one or more amino acids, proteins, dipeptides, nucleotides, nucleic acids, carbohydrates, lipids, or combinations thereof of the sample. In certain embodiments, the low resolution spectral peaks represent glycogen. The low resolution spectral peaks may arise at approximately 480 cm⁻¹, 850 cm⁻¹, and 950 cm⁻¹. In other instances, however, the low resolution spectral peaks do not arise at approximately 480 cm⁻, 850 cm⁻¹, and 950 cm⁻¹. In particular embodiments, the low resolution spectral peaks arise at approximately 720 cm⁻¹, 780 cm⁻¹, and 1580 cm⁻¹. In any one of the foregoing embodiments, low resolution spectral peaks may arise at approximately 830 cm⁻¹, 850 cm⁻¹, 1000 cm⁻¹, 1100 cm⁻¹, 1250 cm ⁻¹, 1370 cm⁻¹, 1480 cm⁻¹, 1580 cm⁻¹, or 1660 cm⁻¹.

### Biological Cell and Tissue Samples

Cell and tissue containing samples (herein referred to collectively as a tissue sample or a cell/tissue sample) used in the methods described in this disclosure may contain cells that may be pre-malignant, malignant (cancerous), or benign. Cell/tissue samples are not limited to a particular type of tissue (based on origin), as most tissues (or cells that constitute the tissue) comprise proteins, nucleic acids, lipids, and carbohydrates. For example, a cell/tissue sample may be from, for example, (obtained from) gynecological (e.g., vaginal, cervical, uterine, ovary), breast, urological, renal, digestive, thyroid, brain, bone marrow, prostate, blood, bone, skin, lymph node tissue, or any other tissue of the body subject to cancer. In particular embodiments, the tissue sample is from cervical tissue.

In certain embodiments, the cell/tissue sample is of epithelial origin. Epithelial cells reside in one or more layers which cover the entire surface of the body and which line most of the hollow structures of the body, excluding the blood vessels, lymph vessels, and the heart interior, which are lined with endothelium, and the chest and abdominal cavities which are lined with mesothelium.

In some embodiments, the cell/tissue sample may be from an epithelial tumor. Examples of epithelial tumors include benign and premalignant epithelial tumors, such as breast fibroadenoma and colon adenoma, and malignant epithelial tumors. Malignant epithelial tumors include primary tumors, also referred to as carcinomas, and secondary tumors, also referred to as metastases of epithelial origin. Carcinomas include acinar carcinoma, acinous carcinoma, alveolar adenocarcinoma (also called adenocystic carcinoma, adenomyoepithelioma, cribriform carcinoma and cylindroma), carcinoma adenomatosum, adenocarcinoma, carcinoma of adrenal cortex, alveolar carcinoma, alveolar cell carcinoma (also called bronchiolar carcinoma, alveolar cell tumor and pulmonary adenomatosis), basal cell carcinoma, carcinoma basocellulare (also called basaloma, or basiloma, and hair matrix carcinoma), basaloid carcinoma, basosquamous cell carcinoma, breast carcinoma, bronchioalveolar carcinoma, bronchiolar carcinoma, bronchogenic carcinoma, cerebriform carcinoma, cholangiocellular carcinoma (also called cholangioma and cholangiocarcinoma), chorionic carcinoma, colloid carcinoma, comedo carcinoma, corpus carcinoma, cribriform carcinoma, carcinoma en cuirasse, carcinoma cutaneum, cylindrical carcinoma, cylindrical cell carcinoma, duct carcinoma, carcinoma durum, embryonal carcinoma, encephaloid carcinoma, epibulbar carcinoma, epidermoid carcinoma, carcinoma epitheliale adenoides, carcinoma exulcere, carcinoma fibrosum, gelatiniform carcinoma, gelatinous carcinoma, giant cell carcinoma, gigantocellulare, glandular carcinoma, granulosa cell carcinoma, hair-matrix carcinoma, hematoid carcinoma, hepatocellular carcinoma (also called hepatoma, malignant hepatoma and hepatocarcinoma), Hurthle cell carcinoma, hyaline carcinoma, hypernephroid carcinoma, infantile embryonal carcinoma, carcinoma in situ, intraepidermal carcinoma, intraepithelial carcinoma, Krompecher's carcinoma, Kulchitzky-cell carcinoma, lenticular carcinoma, carcinoma lenticulare, lipomatous carcinoma, lymphoepithelial carcinoma, carcinoma mastitoides, carcinoma medullare, medullary carcinoma, carcinoma melanodes, melanotic carcinoma, mucinous carcinoma, carcinoma muciparum, carcinoma mucocellulare, mucoepidermoid carcinoma, carcinoma mucosum, mucous carcinoma, carcinoma myxomatodes, nasopharyngeal carcinoma, carcinoma nigrum, oat cell carcinoma, carcinoma ossificans, osteoid carcinoma, ovarian carcinoma, papillary carcinoma, periportal carcinoma, preinvasive carcinoma, prostate carcinoma, renal cell carcinoma of kidney (also called adenocarcinoma of kidney and hypernephoroid carcinoma), reserve cell carcinoma, carcinoma sarcomatodes, scheinderian carcinoma, scirrhous carcinoma, carcinoma scroti, signet-ring cell carcinoma, carcinoma simplex, small-cell carcinoma, solanoid carcinoma, spheroidal cell carcinoma, spindle cell carcinoma, carcinoma spongiosum, squamous carcinoma, squamous cell carcinoma, string carcinoma, carcinoma telangiectaticum, carcinoma telangiectodes, transitional cell carcinoma, carcinoma tuberosum, tuberous carcinoma, verrucous carcinoma, and carcinoma vilosum.

In other embodiments, the cell/tissue sample is of mesenchymal origin, for example, from a sarcoma. Sarcomas are rare mesenchymal neoplasms that arise in bone and soft tissues. Different types of sarcomas include liposarcomas (including myxoid liposarcomas and pleiomorphic liposarcomas), leiomyosarcomas, rhabdomyosarcomas, malignant peripheral nerve sheath tumors (also called malignant schwannomas, neurofibrosarcomas, or neurogenic sarcomas), Ewing's tumors (including Ewing's sarcoma of bone, extraskeletal [not bone] Ewing's sarcoma, and primitive neuroectodermal tumor [PNET]), synovial sarcoma, angiosarcomas, hemangiosarcomas, lymphangiosarcomas, Kaposi's sarcoma, hemangioendothelioma, fibrosarcoma, desmoid tumor (also called aggressive fibromatosis), dermatofibrosarcoma protuberans (DFSP), malignant fibrous histiocytoma (MFH), hemangiopericytoma, malignant mesenchymoma, alveolar soft-part sarcoma, epithelioid sarcoma, clear cell sarcoma, desmoplastic small cell tumor, gastrointestinal stromal tumor (GIST) (also known as GI stromal sarcoma), osteosarcoma (also known as osteogenic sarcoma)-skeletal and extraskeletal, and chondrosarcoma.

In some embodiments, the cell/tissue sample is of melanocytic origin, for example, from a melanoma. Melanomas are tumors arising from the melanocytic system of the skin and other organs. Examples of melanoma include lentigo maligna melanoma, superficial spreading melanoma, nodular melanoma, and acral lentiginous melanoma.

In still other embodiments, the cell/tissue samples are from biliary tract cancer, endometrial cancer, esophageal cancer, gastric cancer, intraepithelial neoplasms, including Bowen's disease and Paget's disease, liver cancer, oral cancer, including squamous cell carcinoma, sarcomas, including fibrosarcoma and osteosarcoma, skin cancer, including melanoma, Kaposi's sarcoma, testicular cancer, including germinal tumors (seminoma, non-seminoma (teratomas, choriocarcinomas)), stromal tumors and germ cell tumors, thyroid cancer, including thyroid adenocarcinoma and medullar carcinoma, and renal cancer including adenocarcinoma and Wilms' tumor.

In particular embodiments, the cell/tissue sample is from bone, muscle or connective tissue. The cell/tissue sample may be from a primary tumor (e.g., sarcoma) of bone and connective tissue.

In other embodiments, the cell/tissue sample is from metastatic tissue. In some embodiments, the metastatic tissue is of epithelial origin. Carcinomas may metastasize to bone, as has been observed with breast cancer, and liver, as is sometimes the case with colon cancer.

In certain embodiments, a cell/tissue sample is obtained directly from an individual or the sample is provided, having previously been obtained. A cell/tissue sample may be obtained by any standard tissue collection method, for example, by biopsy or cell/tissue scraping/exfoliation (e.g., smear). A biopsy may be excisional (removal of an entire area, e.g., lump) or incisional (removal of only a sample of an area). A cell/tissue sample may also be obtained with a needle (e.g., needle aspiration biopsy).

The cell/tissue sample used in any of the embodiments described herein may be fresh, frozen, or fixed. Fixation methods include heat fixation and chemical fixation. A chemically fixation process preserves cell structures in a state (both chemically and structurally) as close to living tissue as possible. A chemical fixative stabilizes proteins, nucleic acids and mucosubstances of the tissue by making them insoluble. Types of chemical fixatives include crosslinking fixatives (e.g., aldehydes such as formaldehyde, paraformaldehyde, formalin, and glutaraldehyde), precipitating fixatives (e.g., alcohols such as ethanol, methanol, acetone, and acetic acid), oxidizing agents (e.g., osmium tetroxide, potassium chloride, chromic acid, and potassium permanganate), mercurials, picrates, and HOPE (Hepes-glutamic acid buffer-mediated organic solvent protection effect) fixative. The type of fixative depends on the cellular target (e.g., proteins, lipids, nucleic acids). Cells/tissue may then be preserved in a wax, such as paraffin, or frozen by immersion in a cryoprotective medium, for example, a water-based glycol, OCT®, CRYOMATRIX®, or CRYO-GEL™, or resin.

In certain embodiments, the tissue sample is a tissue section. Cell/tissue sections may be obtained using a microtome or, in instances when frozen sections are used, a cryostat. Tissue sections may be about 5 microns thick to about 50 microns thick. In some embodiments, the tissue sections are about 10, 15, 20, 30, 35, 40, 45, or 50 microns thick.

In particular embodiments, the cell/tissue sample is collected during a Papanicolaou test (Pap smear). A Pap test is a screening test used in gynecology to detect premalignant and malignant (cancerous) processes in the ectocervix. Significant changes can be treated, thus preventing cervical cancer. In taking a Pap smear, a spatula or cervical brush may be used to gather cells from the outer opening of the cervix of the uterus and the endocervix. According to particular aspects of this disclosure, the cells are examined using the low resolution Raman spectroscopy system to identify abnormalities in the cells. The system and method may be used to detect potentially pre-cancerous changes (called cervical intraepithelial neoplasia (CIN) or cervical dysplasia), or to classify the tissue sample as normal (healthy, non-cancerous). The methods may also detect infections and abnormalities in the endocervix and endometrium. In other embodiments, an anal Pap smear is used to detect anal cancers.

### Low Resolution Raman Spectroscopy System

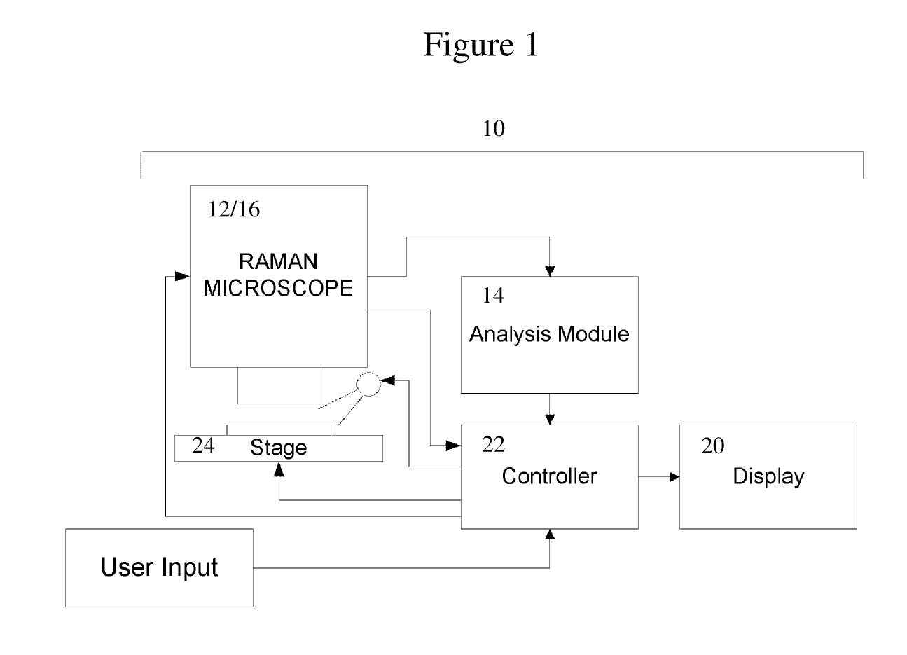

Referring to FIG. 1, in certain embodiments of the invention, a low resolution Raman spectroscopy (LRRS) system 10 is provided that comprises a low resolution Raman spectrometer 12 integrated with an analysis module 14 (configured for analyzing Raman spectra according to analysis methods of the invention). In some embodiments, the low resolution spectrometer is portable. In any one of the foregoing embodiments, the Raman spectrometer may be integrated with or coupled to an optical microscope 16. In some embodiments, the optical microscope and Raman spectrometer may have one or more common objective lens (e.g., 4×, 10×, 20×, 50×, 100×), for alignment and/or imaging purposes. In related embodiments, the Raman spectrometer may be configured such that the area of measurement corresponds to a central region of the viewable area of the sample imaged by the microscope. In any one of the foregoing embodiments, the LRRS system may comprise a display 18. The display may be integrated with or coupled to the Raman spectrometer and/or analysis module. In any one of the foregoing embodiments, the LRRS system may comprises a graphical user interface 20 (GUI), which may be viewable on the display. In any one of the foregoing embodiments, the LRRS may comprise a controller 22 and/or a controllable stage 24. The controller may be separate from or integrated into a computer system comprising the analysis module and/or display and/or GUI.

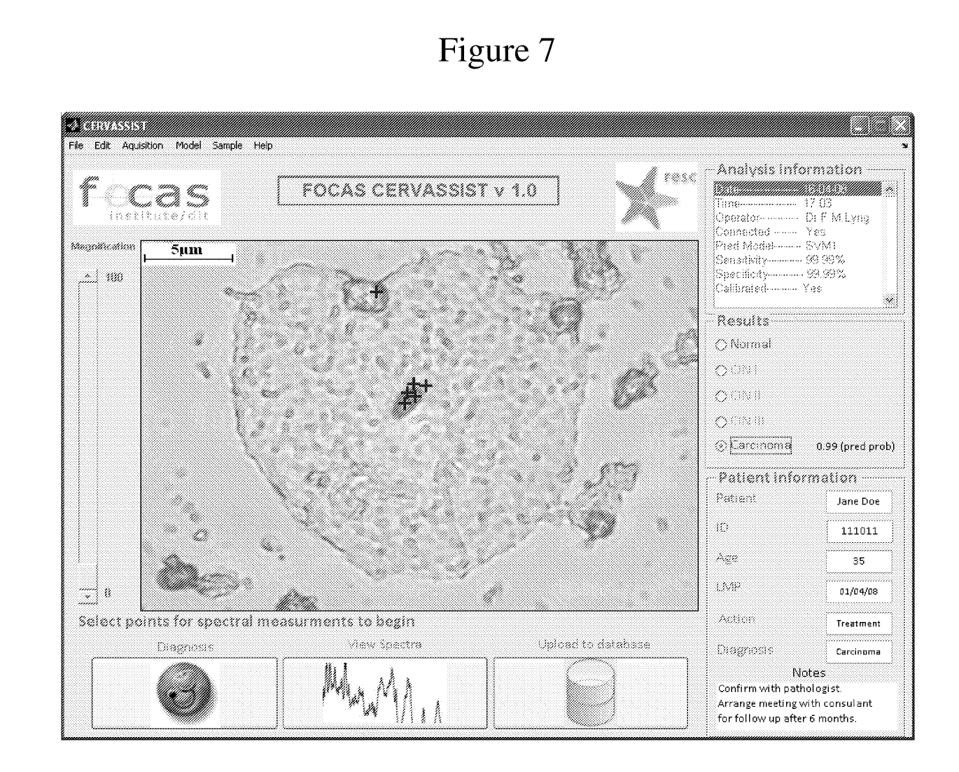

In particular embodiments, the LRRS system allows a user to point and select (using a pointing device such as a mouse, or a touchscreen (e.g. see FIG. 7) in instances where the LRRS system comprises a touchscreen display) on an area of interest in a tissue sample resolved on the display and acquire a Raman spectrum or a number of spectra from individual cells (e.g., within a tissue sample). In particular embodiments, the methods described herein provide a means to acquire spectra from a tissue sample (or cells of a tissue sample) without the use of a confocal microscope. In related embodiments, the display (optionally with a GUI) and analysis module permits the use of the LRRS system without any type of optical microscope.

### Low Resolution Raman Spectrometer (LRRS)

Spectral resolution in a dispersive Raman spectrometer is determined by four main factors. Below, the effect of each factor is considered under the assumption that all other factors remain unchanged. In practice, all of these factors can exist in many varied permutations.

Spectrometer focal length—the longer the focal length (e.g., the distance between the dispersing grating and detector) of the spectrometer, the higher the spectral resolution. In certain embodiments, the low resolution Raman spectrometer used with certain of the embodiments described herein will have focal lengths ranging from approximately 200 mm to 600 mm. In particular embodiments, the low resolution spectrometer has a focal length of approximately 200, 300, 400, 500, or 600 mm. A long focal length spectrometer, however, is not limited to high resolution work only. In certain other embodiments, a high resolution spectrometer (with a focal length of greater than 600 mm) can be run in a low resolution mode if a suitable grating is chosen, as described below.

Diffraction grating—the higher the groove density of the grating (typically measured as number of grooves per millimeter), the higher the spectral resolution. In particular embodiments, the low resolution spectrometer used with any one of the embodiments described herein has a grating of approximately 200 gr/mm to 1200 gr/mm. In some embodiments, the grating is approximately 200, 300, 400, 500, 600, 700, 800, 900, 1000, 1100, or 1200 gr/mm. In other embodiments, the grating is 600 gr/mm.

Laser wavelength—the dispersing power of a grating/spectrometer pair may be considered constant in terms of wavelength. However, Raman spectra use an energy related unit (Raman shift, or wavenumber, cm⁻¹) which means that the spectral resolution decreases as the laser excitation is changed from infra-red to visible to ultra-violet wavelengths. As an example, if a 600 gr/mm grating is used with an infra-red laser, a 1200 gr/mm or 1800 gr/mm will be required with a green laser to achieve a similar resolution. In certain embodiments herein, a spectra acquired with low resolution Raman spectrometer have a resolution of about or greater than 3 wavenumbers. In other embodiments, the spectra have a resolution of about 3, 4, 5, 6, 7, 8, 9, or 10 wavenumbers.

Detector—many systems have a single detector, but different detectors can be configured with different pixel sizes. The larger the pixel size, the lower the spectral resolution.

Certain aspects of this disclosure relate to LRRS systems comprising a portable Raman spectrometer. A portable (compact, lightweight,) spectrometer is one that can be manually moved, for example, from one bench top surface to another, or it may be handheld. Examples of portable low resolution spectrometers useful or potentially useful for practicing certain embodiments of the invention include but are not limited to: RMP-300 Portable Raman Spectrometers, such as models RMP-310, 315, 320, and 325 (JASCO, Inc., U.S.A.); DELTANU® handheld spectrometers, such as INSPECTOR RAMAN™, REPORTER™, PHARMA. ID™, OBSERVER™, OBSERVER LR™, and those portable spectrometers of the Advantage Series (Intevac, Inc., U.S.A.); INPHOTOTE™ Portable Raman System (InPhotonics, Inc., U.S.A.); AHURA FIRSTDEFENDER® (Thermo Fisher Scientific, Inc., U.S.A.); and EZRAMAN-M™ Series (Enwave Optronics, Inc., U.S.A.).

### Computer Implemented Control and Analysis Module Systems

Certain embodiments of the low resolution Raman spectroscopy (LRRS) system include one or more controllers/computer implemented control systems for operating various components/subsystems of the system, performing data/image analysis, etc. (e.g., as shown in FIG. 1). In general, any calculation methods, steps, simulations, algorithms, systems, and system elements described herein may be implemented and/or controlled using one or more computer implemented system(s), such as the various embodiments of computer implemented systems described below. The methods, steps, control/analytical systems, and control/analytical system elements described herein are not limited in their implementation to any specific computer system described herein, as many other different machines may be used.

The computer implemented system(s) can be part of or coupled in operative association with an image analysis system and/or other automated system components, and, in some embodiments, is configured and/or programmed to control and adjust operational parameters, as well as analyze and calculate values, for example produce, process and/or classify tissue sample spectra (e.g., malignant v. benign) based on its comparison to reference spectra. In some embodiments, the computer-implemented system(s) can send and receive reference signals to set and/or control operating parameters of system apparatus. In other embodiments, the computer implemented system(s) can be separate from and/or remotely located with respect to the other system components and may be configured to receive data from one or more remote assay systems of the invention via indirect and/or portable means, such as via portable electronic data storage devices, such as magnetic disks, or via communication over a computer network, such as the Internet or a local intranet.

The computer implemented system(s) may include several known components and circuitry, including a processing unit (i.e., processor), a memory system, input and output devices and interfaces (e.g., an interconnection mechanism), as well as other components, such as transport circuitry (e.g., one or more busses), a video and audio data input/output (I/O) subsystem, special-purpose hardware, as well as other components and circuitry, as described below in more detail. Further, the computer system(s) may be a multi-processor computer system or may include multiple computers connected over a computer network.

The computer implemented control system(s) may include a processor, for example, a commercially available processor such as one of the series x86, Celeron and Pentium processors, available from Intel, similar devices from AMD and Cyrix, the 680X0 series microprocessors available from Motorola, and the PowerPC microprocessor from IBM. Many other processors are available, and the computer system is not limited to a particular processor.

A processor typically executes a program called an operating system, of which WindowsNT, Windows95 or 98, Windows XP, Windows Vista, Windows 7, UNIX, Linux, DOS, VMS, MacOS and OS8 are examples, which controls the execution of other computer programs and provides scheduling, debugging, input/output control, accounting, compilation, storage assignment, data management and memory management, communication control and related services. The processor and operating system together define a computer platform for which application programs in high-level programming languages are written. The computer implemented system is not limited to a particular computer platform.

The computer implemented system(s) may include a memory system, which typically includes a computer readable and writeable non-volatile recording medium, of which a magnetic disk, optical disk, a flash memory and tape are examples. Such a recording medium may be removable, for example, a floppy disk, read/write CD or memory stick, or may be permanent, for example, a hard drive.

Such a recording medium stores signals, typically in binary form (i.e., a form interpreted as a sequence of one and zeros). A disk (e.g., magnetic or optical) has a number of tracks, on which such signals may be stored, typically in binary form, i.e., a form interpreted as a sequence of ones and zeros. Such signals may define a software program, e.g., an application program, to be executed by the microprocessor, or information to be processed by the application program.

The memory system of the computer implemented system(s) also may include an integrated circuit memory element, which typically is a volatile, random access memory such as a dynamic random access memory (DRAM) or static memory (SRAM). Typically, in operation, the processor causes programs and data to be read from the non-volatile recording medium into the integrated circuit memory element, which typically allows for faster access to the program instructions and data by the processor than does the non-volatile recording medium.

The processor generally manipulates the data within the integrated circuit memory element in accordance with the program instructions and then copies the manipulated data to the non-volatile recording medium after processing is completed. A variety of mechanisms are known for managing data movement between the non-volatile recording medium and the integrated circuit memory element, and the computer implemented system(s) that implements the methods, steps, systems control and system elements control described above is not limited thereto. The computer implemented system(s) is not limited to a particular memory system.

At least part of such a memory system described above may be used to store one or more data structures (e.g., Raman spectra) or equations such as calibration curve equations, statistical analysis equations, data analysis algorithms, etc. For example, at least part of the non-volatile recording medium may store at least part of a database that includes one or more of such data structures. Such a database may be any of a variety of types of databases, for example, a file system including one or more flat-file data structures where data is organized into data units separated by delimiters, a relational database where data is organized into data units stored in tables, an object-oriented database where data is organized into data units stored as objects, another type of database, or any combination thereof.

The computer implemented system(s) may include a video and audio data I/O subsystem. An audio portion of the subsystem may include an analog-to-digital (A/D) converter, which receives analog audio information and converts it to digital information. The digital information may be compressed using known compression systems for storage on the hard disk to use at another time. A typical video portion of the I/O subsystem may include a video image compressor/decompressor of which many are known in the art. Such compressor/decompressors convert analog video information into compressed digital information, and vice-versa. The compressed digital information may be stored on hard disk for use at a later time.

The computer implemented system(s) may include one or more output devices. Example output devices include a cathode ray tube (CRT) display, liquid crystal displays (LCD) and other video output devices, printers, communication devices such as a modem or network interface, storage devices such as disk or tape, and audio output devices such as a speaker.

The computer implemented control system(s) also may include one or more input devices. Example input devices include a keyboard, keypad, track ball, mouse, pen and tablet, communication devices such as described above, and data input devices such as audio and video capture devices and sensors. The computer implemented system(s) is not limited to the particular input or output devices described herein.

It should be appreciated that one or more of any type of computer implemented system may be used to implement various embodiments described herein. Aspects of the invention may be implemented in software, hardware or firmware, or any combination thereof. The computer implemented system(s) may include specially programmed, special purpose hardware, for example, an application-specific integrated circuit (ASIC). Such special-purpose hardware may be configured to implement one or more of the methods, steps, simulations, algorithms, systems control, and system elements control described above as part of the computer implemented control system(s) described above or as an independent component.

The computer implemented system(s) and components thereof may be programmable using any of a variety of one or more suitable computer programming languages. Such languages may include procedural programming languages, for example, LabView, C, Pascal, Fortran and BASIC, object-oriented languages, for example, C++, Java and Eiffel and other languages, such as a scripting language or even assembly language.

The methods, steps, simulations, algorithms, systems control, and system elements control may be implemented using any of a variety of suitable programming languages, including procedural programming languages, object-oriented programming languages, other languages and combinations thereof, which may be executed by such a computer system. Such methods, steps, simulations, algorithms, systems control, and system elements control can be implemented as separate modules of a computer program, or can be implemented individually as separate computer programs. Such modules and programs can be executed on separate computers.

Such methods, steps, simulations, algorithms, systems control, and system elements control, either individually or in combination, may be implemented as a computer program product tangibly embodied as computer-readable signals on a computer-readable medium, for example, a non-volatile recording medium, an integrated circuit memory element, or a combination thereof. For each such method, step, simulation, algorithm, system control, or system element control, such a computer program product may comprise computer-readable signals tangibly embodied on the computer-readable medium that define instructions, for example, as part of one or more programs/files, that, as a result of being executed by a computer, instruct the computer to perform the method, step, simulation, algorithm, system control, or system element control.

### Graphical User Interface and Analysis Module

In some embodiments, the low resolution Raman spectroscopy system comprises a graphical user interface (GUI) with a window displaying the view from, for example, a microscope or other imaging system (e.g., the image may be acquired by a digital camera or similar imaging device). The GUI may be configured to permit a user to use a pointing device (e.g., mouse, touchpad, etc.) to identify one or more areas of interest in the cell/tissue sample. The GUI may also be configured using an electronic visual display that can detect the presence and location of a touch within the display area (e.g., touchscreen display). In some embodiments, the GUI is used in combination with other system components, such as an analysis module, to acquire and resolve an image of the cell/tissue sample, select a sampling area, display one or more acquired spectra, and/or display the classification (e.g., malignant v. benign) of cell/tissue sample. An example of a GUI displaying a cell/tissue sample of interest is shown in FIG. 7. In this example, the user has selected particular points within the cell/tissue for spectral measurement. The integrated low resolution Raman spectroscopy system acquires spectra from these particular points, analyzes the spectra, and the GUI then displays the tissue/cell classification, in this case, carcinoma.

In certain embodiments, the low resolution Raman spectroscopy system comprises an analysis module configured to perform image analyses on an image (e.g., from a microscope and/or acquired by a digital camera) to identify areas of interest. In particular embodiments, the image analysis identifies (and may magnify) cells as areas of interest. In some embodiments, the analysis module comprises a software component for analyzing Raman spectra. In certain embodiments, the software component uses a pattern recognition model/algorithm (described below) to compare and classify Raman spectra acquired from cells and tissues of interest (e.g., normal and abnormal cells/tissue). There may also be a statistical component to the analysis module. Examples of software programs that may be used with any one of the embodiments described herein include, but are not limited to, MATLAB® (matrix laboratory)(The MathWorks®, Inc., U.S.A.), FLEXPRO®, FreeMat, GNU Octave, Jacket, Jasymca, jBEAM®, scalalab, EngLab, LabVIEW, Mathnium, Rlab, SIMPLEXNUMERICA®, Scilab®, Sysquake, and Metlynx. In certain embodiments, custom designed software and/or modifications of the above listed or other commercially available software products may be used instead of or in addition to one or more of the above mentioned or other commercially available software products to implement one or more of the models/algorithms described herein.

### Stage, Controller, and Light Source

In certain embodiments, a movable stage is provided below an objective lens and is configured to receive a (microscope) slide. This may be, for example, by means of a recess in the shape of the slide or guides on the surface. The movable stage may be responsive to a controller to effect motion of the stage and thus the area of the slide under the collection optics. The stage, in certain embodiments, is effectively a device which may be operated to move the sample along at least the x and y axes. In certain embodiments, the stage has stepper motors or similar devices to ensure the stage moves to a required position, as provided by the controller. A controller may operate the stage in response to a user input for example, by means of a joystick or similar device, or it may be automated.

In related embodiments, the system further comprises a visible light source for illuminating the slide. In some embodiments, the light source is switchable directly in response to an input from the controller to illuminate the slide or not illuminate the slide, for example, when the Raman spectrometer is in use. In other embodiments, a mechanical or electronic shutter responsive to the controller is employed to switch on\off the illumination of the slide as required by blocking\unblocking the optical path between the slide and the light source. In certain embodiments, the light source is a fiber optic light.

In some embodiments, a moveable mirror or similar reflective feature is provided to switch the optical path between that of the viewing optics of the microscope and those of the Raman spectrometer. In certain embodiments, the minor is switched in response to a signal from the controller.

### Modes of Operation

In certain embodiments, a user places a slide carrying a sample to be investigated on the stage. The optics are switched such that the user is able to view the sample under the microscope, for example within a window on the display (FIG. 7). Initially, the controller operates the stage in response to the user input for example by means of a touch screen, joystick or mouse. This allows a user to view different areas on the slide. As the user views a particular area, he or she may consider whether a particular area within the frame, for example, a cell or cell component, is suspicious (e.g., has a visual abnormality). The user can position a cursor on the area of interest within the window displaying the microscope view. Once the cursor is positioned, the user can select the position (e.g., click a mouse button) to activate the analysis steps (e.g., FIG. 7, “x” marks visual abnormalities selected for analysis). Once activated, the controller may be configured to determine the distance, both x and y, that the stage moves to position the area of interest in the center of the optical axis of the Raman microscope. This information may then be transmitted to the stage as a control signal to cause the area of interest to be positioned centrally. The light is then switched off, the optics switched to the Raman spectrometer, and a laser is activated. The spectrum (or spectra) of the area of interest is then acquired. The controller may then move the stage to its initial position. The analysis module performs an analysis on the acquired spectrum to compare it with a library of pre-recorded spectra from a wide sample base including, for example, classes of cervical intraepithelial neoplasia (e.g., CIN I, II and III). An algorithm, as will be described below, may then be employed which classifies the spectrum into the most appropriate group, and an identification of the classification result may be returned, for example, via a display window (optionally with a graphical user interface) (e.g., FIG. 7, left hand side of display indicates carcinoma). An advantage of such an embodiment is that a conventionally trained user may quickly and systematically analyze cells using a simple point and click process without specialized training or technical expertise in Raman spectroscopy, such as typically required to operate high resolution Raman systems.

In other embodiments, the system is automated, whereby the whole cell/tissue sample may be scanned and abnormal areas identified, highlighted, and classified for subsequent review (e.g., by a medical professional). In certain embodiments, a light source is activated by the controller to illuminate the sample. The entire area of the sample may then captured by a digital camera as a series of frames to provide a digital image of the sample. The frames may be analyzed individually as they are acquired or as a single process on the entire digital image. The digital image may be stored for subsequent viewing by a user. In particular embodiments, the digital image/individual frames are analyzed using image analysis to identify cells and other features of potential interest within the image. It is understood that techniques for performing this type of image analysis are familiar to those skilled in the field and may include, for example, the use of edge and boundary detection techniques. More advanced techniques may also be employed to limit the identification to suspect cells. Where a cell or other feature is identified as being of interest, its position (e.g., along an x and y axis) is recorded (acquired). In some embodiments, this process is repeated for the entire digital image. Once this step is completed, in some instances, the controller moves the stage to center the first identified location on the optical axis, the light is switched off, the optics switched to the Raman spectrometer and the laser activated. A spectrum of the area of interest may then be taken and analyzed as described previously with respect to the first mode and in greater detail below. The result of the analysis may then be stored with the location. This process may then be repeated for all of the identified locations within the tissue sample. Once the measurements and analysis for each location have been completed, in some instance, the controller may check to determine whether any locations were identified as being cancerous in nature. If not, the system may request the removal of the slide and insertion of the next. In certain aspects of this disclosure, an automated feed system may be provided to feed slides in succession. If the system identifies one or more areas as being within a particular cell classification of concern, e.g., malignant/cancerous, then a warning or alert may be provided to a user, for example, in the form of a message on the display or an audible warning. The interface may then present the user with a sequential view of the identified areas from the digital image to allow the user to confirm the result.

In certain embodiments of the methods and systems described herein, Raman spectra are analyzed by an analysis module employing one or more computer implemented models/algorithms. For example, a model/algorithm for classification of unknown cell/tissue samples compares the sample spectra to a large reference dataset of, e.g., normal, invasive carcinoma, and CIN I, II and III cell/tissue samples, and assigns the spectra to the most similar group (e.g., based on, for example, similarity of spectral peak size and positions.

### Supervised Pattern Recognition Model/Algorithm Design

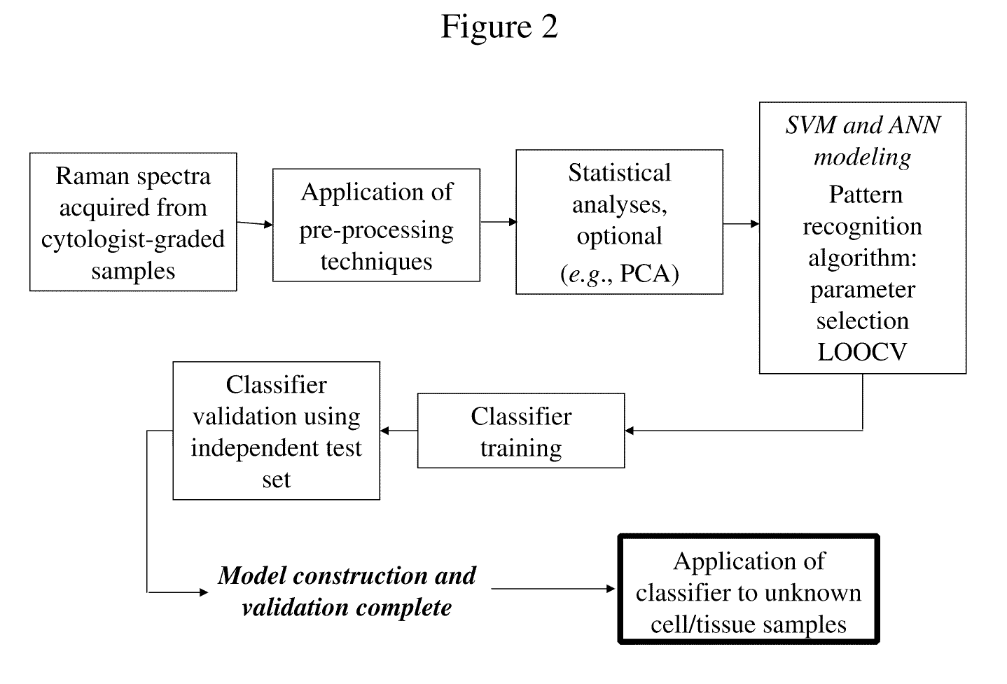

An exemplary embodiment of the creation of a reference dataset and a classification model/algorithm for use with certain embodiments of a low resolution Raman spectroscopy (LRRS) system, provided herein, is outlined in FIG. 2 and described below. Any one of the steps described herein for the creation of a reference dataset and a classification model/algorithm may be performed using a mathematical software program. In some embodiments, the software program MATLAB® (matrix laboratory) (The MathWorks®, Inc., U.S.A.) is used. In other embodiments FLEXPRO®, FreeMat, GNU Octave, Jacket, Jasymca, jBEAM®, scalalab, EngLab, LabVIEW, Mathnium, Rlab, SIMPLEXNUMERICA®, Scilab®, Sysquake, or Metlynx may be used. In certain embodiments, the computer software program may be custom-made.

Step 1: Raman Spectra are Acquired from Cytologist-Graded Cell/Tissue Samples.

A reference dataset of Raman spectra from known cell/tissue samples is initially generated. In certain embodiments, the cell/tissue samples have been classified as normal or abnormal (e.g., premalignant, malignant) by a cytologist or pathologist using methods known to those of ordinary skill in the art (e.g., histopathology or Pap test). In some embodiments, the reference database comprises a range of normal and abnormal cell/tissue samples for diagnostic purposes, e.g., cervical tissue for cervical cancer diagnosis. For example, a reference database of cervical tissue may comprise one or more negative (normal cytology), CIN I (mild dysplasia), CIN II (moderate dysplasia), and/or CIN III (severe dysplasia) cell/tissue samples. Raman spectra are recorded from known cell/tissue samples to build a reference dataset.

### Step 2: Application of Pre-Processing Techniques.

Following the acquisition of Raman spectroscopy measurements from the known cell/tissue samples (of the reference dataset), pre-processing techniques can be performed to reduce the experimental variance in the reference dataset. Suitable pre-processing techniques are known to one of ordinary skill in the art and may include: smoothing, normalization, and derivatization (Lewis et al. Handbook of Raman spectroscopy: from the research laboratory to the process line, 2001; Afseth et al., Applied Spectroscopy, 2006, 60(12):1358-1367; Gobinet et al. IEEE Trans Biomed Eng., 2009, 56(5):1371-82). Smoothing methods attempt to remove random wavenumber to wavenumber variations, thus removing noise from Raman spectra. For example, for each wavenumber in a spectrum, the intensity may be replaced with an average of the surrounding wavenumbers. However, over-smoothing can result in a loss of information, so smoothing is terminated before any information is lost. This step reduces variation by removing random fluctuation by highlighting dominant trends across the spectrum. Normalization methods transforms Raman spectral intensity to a new scale (e.g., 0 to 1). For example, a cell/tissue spectrum can be normalized to its maximum intensity. The process involves subtracting the minimum intensity observed (thus making minimum=0) and then dividing by maximum intensity (thus making the maximum observed=1) to rescale the spectrum. This process continues for each spectrum in the reference dataset. This step reduces variation by internally controlling spectrum to spectrum variations in the Raman spectrometer. Derivatization refers to the calculation of derivatives of spectra (e.g., 1^{st} or 2^{nd} order), and may be used to resolve overlapping spectral bands, thereby exposing overlapping peaks that are observed as shoulders on the original spectral peaks. Derivatization reduces variation arising from changes in these “hidden” peaks that may have been considered noise on the original cell/tissue sample spectra.

### Step 3: Unsupervised Multivariate Analysis (Optional)

Exemplary multivariate statistical analysis techniques that may be employed in any one of the embodiments described herein include those that fall under two main categories: unsupervised and supervised. In certain embodiments, an unsupervised multivariate analysis may be used to determine the spectral regions resulting in separation between the different cell/tissue samples. Unsupervised techniques, such as principal component analysis (PCA), assume no prior knowledge of the cell/tissue sample (Pearson, K., 1901, Philosophical Magazine, 1901, 2(6)L559-582; Jolliffe, I. T., Principal component Analysis, 1986, Springer-Verlag).

PCA is primarily applied to reduce the computational intensity required to develop supervised pattern recognition models (e.g., partial least squares (PLS) regression, support vector machines (SVM), artificial neural networks (ANN), and linear discriminant analysis (LDA)). An additional benefit of PCA is that noise can be removed from the cell/tissue spectra. Noise refers to any measurement variation unrelated to the cell/tissue sample. For example, variations in the Raman spectra can arise from a variety of sources ranging from fluctuations in the Raman spectrometer detector electronics to the underlying substrate that the cell/tissue sample is on (e.g., a glass microscope slide). Noise is removed or reduced because PCA reorganizes the data with respect to the principal components of variance, therefore the majority of the information contained in the original cell/tissue sample spectrum is present in a lower number of vectors. Vectors having a low level of variance from the original cell/tissue dataset can be removed with minimal loss of information. Yet another advantage of PCA is the ability to reveal outliers within the spectral cell/tissue dataset and to remove them, thus increasing the final accuracy of the low resolution Raman spectroscopy system. Outliers refer to samples that are phenotypically similar, producing radically different spectra.

### Step 4: Generation of a Supervised Pattern Recognition Model

Next, in certain embodiments a supervised pattern recognition (classification) model/algorithm is generated. In some embodiments, a support vector machine (SVM) is generated (Vladimir, N. V.:, The nature of statistical learning theory, 1995. Springer-Verlag New York, Inc.; Burges, C., A Tutorial on Support Vector Machines or Pattern Recognition, Data Mining and Knowledge Discovery, 1998, 2:121-167; Lin C-CCaC-J: LIBSVM: a library for support vector machines). In other embodiments, an artificial neural network (ANN) is generated (Mcculloch, et al., Bulletin of Mathematical Biology, 1990, 52:99-115; Yao, et al. Proceedings of the 1999 Congress on Evolutionary Computation, 1999, 3:1767; Jain, et al. Computer, 1996, 29:31).

Step 4a: Generation of a Supervised Pattern Recognition Model—Parameter Selection Using Cross-Validation

To generate such a model, particular mathematical parameters may be chosen, which are well-known to those of ordinary skill in the art (see references above relating to SVMs and ANNs). In particular embodiments where a SVM model is used, at least two different parameters to build a classification model may be chosen. For example, a “kernel type” parameter controls mapping of spectral data from input space to higher dimensional space where spectral data may be more separable. In certain embodiments, depending on the type of kernel used, additional parameters may be required, for example, a “penalty” parameter, which controls the trade-off between accuracy and model complexity.

In some embodiments, model/algorithm parameters are chosen using an initial statistical re-sampling routine known as “cross-validation” to estimate the success of each the selected parameters with a portion of the data known as the cross-validation (CV) set. In certain embodiments, 25% of the data is known as the cross-validation set, while in other embodiments, there is no set percentage, just general guides based on the size of the total dataset. There are various types of cross validation (e.g., n-fold CV, leave-one-out or leave one patient CV, cross-model validation), which may be employed. In particular embodiments, leave-one-out cross-validation (LOOCV) is used. In LOOCV, a series of models are built using n-1 (removed) cell/tissue samples. The removed cell/tissue sample is presented to the mathematical model, and a prediction of, for example, normal or abnormal is made. The process may be continued until each sample is left out. The aim is to attempt to determine if model overfitting has occurred without the use of an independent testing set. “Overfitting” is a phenomenon that occurs when using complex machine learning algorithms on noisy multidimensional data. During the parameter selection stage, there may be an attempt to offset an overfitting risk. Overfitted models memorize the reference dataset/training data (spectra from known cell classes) too closely, resulting in an inability to correctly classify unknown cell/tissue samples. During each stage of model building, precautions may be taken to offset the overfitting risk and ensure the model has sufficient or optimal generalization ability on new data. For example, precautions may include data order randomization, cross validation, and independent test set validation. In particular embodiments, when overfitting concerns are increased when selecting a variable, even more conservative estimates of model performance may be employed.

Following the application of LOOCV, the accuracy of cell classification (prediction) can be calculated as well as the sensitivity and specificity of the model. The model accuracy is the number of correct results divided by the total number of cell/tissue samples, converted to a percentage. In addition, other measures of performance may be employed, such as sensitivity and specificity.

Step 4b: Generation of a Supervised Pattern Recognition Model—Training the Model

Once the parameters have been selected, a model may be trained using another portion of the data set not used for cross validation (e.g., 50% of the data). In certain embodiments, the spectral patterns within the cell/tissue sample data can be ‘learned’ by the SVM or ANN model using the cell/tissue reference dataset (based on the cytologist/pathologist classification). From this trained model, predictive models may be developed to classify unknown cell/tissue samples (e.g., normal, abnormal, pre-malignant, or malignant).

Step 4c: Generation of a Supervised Pattern Recognition Model—Independent Test Set Validation

In related embodiments, model/algorithm may be evaluated by independent test set validation. For example, the remaining portion of the data (e.g., 25% of the data) not used in parameter selection or training the model is presented blind to the model. The model then classifies the unknown samples and the predicted classes can be checked against the known classification from the cytologist/pathologist. The values returned are predictive of the strength of the model.

Sensitivity and specificity values can also be calculated, in some embodiments. Sensitivity refers to the probability of a positive test among patients with disease, while specificity refers to the probability of a negative test among patients without disease. Once a model has been constructed and validated, it may then be used for classification of unknown samples, e.g., a separate set of patient cell/tissue samples where the classification is not known.

To allow non-specialist users (e.g., hospital technicians) to operate the classification algorithm, a user friendly graphical user interface (GUI) may be used (FIG. 7). The interface allows a user to select an area for acquisition of spectra by the Raman microscope and presents the classification of a selected area. As with other diagnostic systems, the GUI may be connected to a secure relational database for model and diagnosis results. As with other database systems, a clinician may also be able to add patient data and specific sample notes and recommendations for further actions to be taken. In particular embodiments, higher specificity and sensitivity values than the currently used cytological methods may be obtained.

### EXAMPLES

### General Methodology

Patient samples were obtained as for liquid based cytology (Thin prep). They were placed in PreservCyt solution in a vial and sent to the laboratory for testing. The Thin prep slide was prepared as for cytology. The cells in the vial were transferred to a glass slide using a Thin prep processor. The slide was not stained with the Papanicolaou stain. The slide was placed on a low resolution Raman microscope stage and quickly scanned under the 10× objective lens. If any areas of the slide appeared suspicious, the 40× and 100× objective lens was used to zoom in on the suspicious cells. The light on the microscope was switched off and the microscope was switched to low resolution Raman mode—this allowed the laser to shine on the sample through the objective lens and the resulting Raman scatter to be collected again through the objective lens. The Raman scattered light reached the detector to give a low resolution Raman spectrum. Raman spectra were acquired/recorded from the suspicious cells or from a range of morphologically normal epithelial cells (if no suspicious cells were observed). An algorithm, as described above, was used to analyze these spectra and produce a classification. This classification (e.g., carcinoma) was returned via a graphical user interface.

### Example 1

### Comparison of Low and High Resolution Raman Spectroscopy in Normal and Abnormal Tissue Sections

Formalin-fixed paraffin preserved (FFPP) tissue samples were obtained from the National Maternity Hospital, Holles St., Dublin. Two parallel 10 μm FFPP sections were cut from each block using a microtome, mounted on glass slides and dried. Samples were dewaxed by immersion in hexane. One section from each sample (the reference section) was stained with hematoxylin and eosin and the other kept unstained for spectroscopic examination. FFPP cervical tissue sections were characterized by a consultant pathologist at the National Maternity Hospital, Holles St., Dublin, and the samples consisted of 20 normal and 20 invasive carcinoma sections from 40 patients. Of the 20 carcinoma samples, 10 samples were identified as having various grades of cervical intraepithelial neoplasia (CIN), which were also marked for examination.

An Instruments S.A. (now Horiba Jobin Yvon) Labram 1B Raman spectroscopic confocal microscope was used, with an argon ion laser operating at a wavelength of 514.5 nm. The laser power at the sample was measured and found to be 7.50±0.05 mW. The scattered light was collected by the objective lens and dispersed onto an air cooled CCD detector (1024×256 pixels) by the grating. The dispersion (resolution) of the system operating with the 1800 lines/mm grating was 1.65 cm⁻¹/pixel (high resolution) and with the 600 lines/mm grating was 4.95 cm⁻¹/pixel (low resolution).

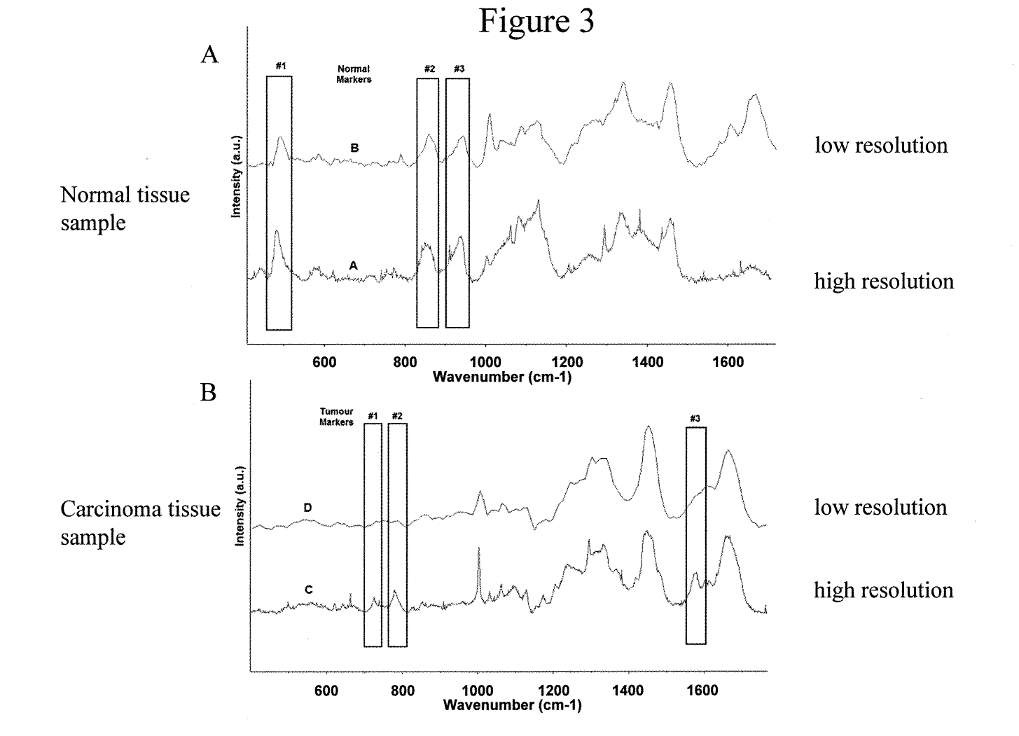

For the low resolution spectroscopy of the tissue sections, principal component analysis-linear discriminant analysis (PCA-LDA) was used to classify unknown sections using previously recorded spectra of normal and abnormal samples as a reference/calibration dataset. FIG. 3A shows Raman spectra for normal cervical tissue at low resolution (top) and high resolution (bottom). Glycogen peaks were evident at (#1) 480 cm⁻¹, (#2) 850 cm⁻¹, and (#3) 950 cm⁻¹. FIG. 3B shows Raman spectra for abnormal cervical tissue at low resolution (top) and high resolution (bottom). Nucleic acid peaks were evident at (#1) 720 cm⁻¹, (#2) 780 cm⁻¹, and (#3) 1580 cm⁻¹,

All spectra (unfiltered) were subjected to spurious peak (“cosmic ray”) removal and baseline correction using a common baseline, in Labspec (v. 4.02 Jobin Yvon), before being exported in ASCII format to Microsoft Excel. Spectra were normalized to the spectral maximum, from 0 to 1. Basic matrix manipulations and data reduction were carried out in Microsoft Excel Professional 2003 (v. 11.0), before being exported into Minitab to perform principal component analysis (PCA) and linear discriminant analysis (LDA). Minitab Release 14.1 Statistical Software Analysis Programme was used to produce PCA scores and LDA plots, as well as to carry out leave-one-out cross validation.

PCA-LDA permitted a prediction accuracy of 93.4%, with sensitivity and specificity values of 99.5% and 100% for normal tissue, 94.2% and 92.8% for tumor tissue and 78.9% and 97% for CIN tissue.

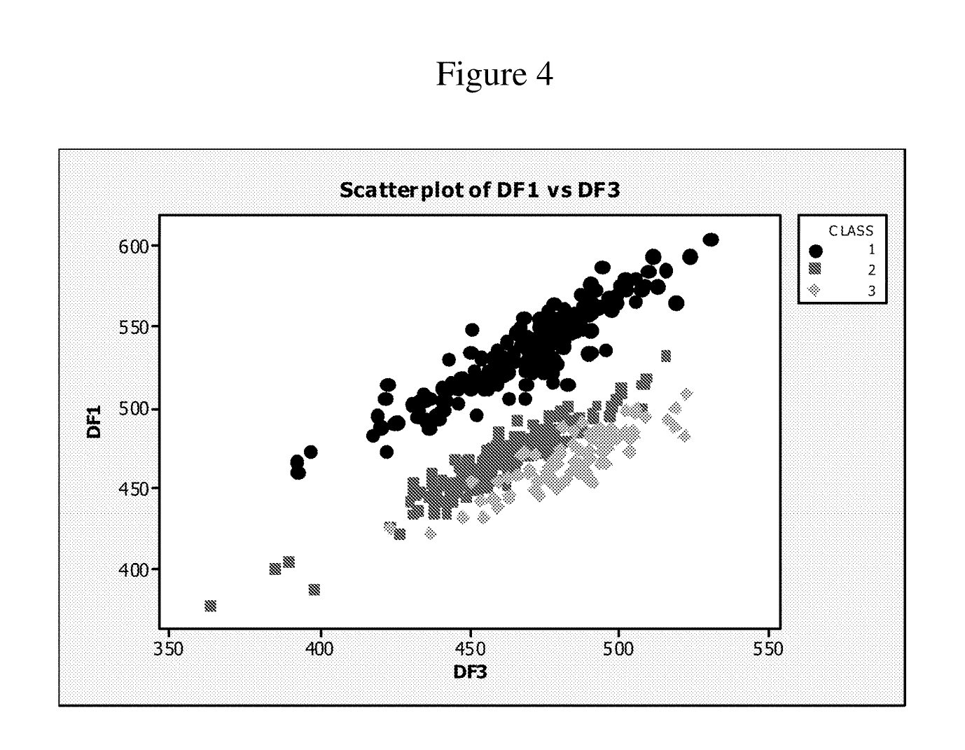

FIG. 4 illustrates multivariate analysis (principle component analysis (PCA)) of data, showing differentiation between normal epithelial tissue (class 1), invasive carcinoma (class 2), and CIN tissue (class 3).

### Example 2

### Comparison of Low and High Resolution Raman Spectroscopy in Normal and Abnormal Smears

Cervical cytology samples were obtained from the National Maternity Hospital, Holles St., Dublin and the Coombe Women and Infants University Hospital, Dublin. Samples were collected by scraping of the cervix using the THINPREP® Pap Test Cervex-Brush protocol. Cervical cells were fixed in PRESERVCYT® solution (Cytyc Corporation, Marlborough, USA).

The cells were transferred onto a microscopic slide using a CYTOSPIN® centrifuge (Cytospin3, Shandon, USA). The samples were left to air dry and were analyzed unstained. After Raman analysis, the samples were stained with the Papanicolaou stain and coverslipped. The cells from which Raman spectra were acquired were re-visited and assessed by a cytologist.

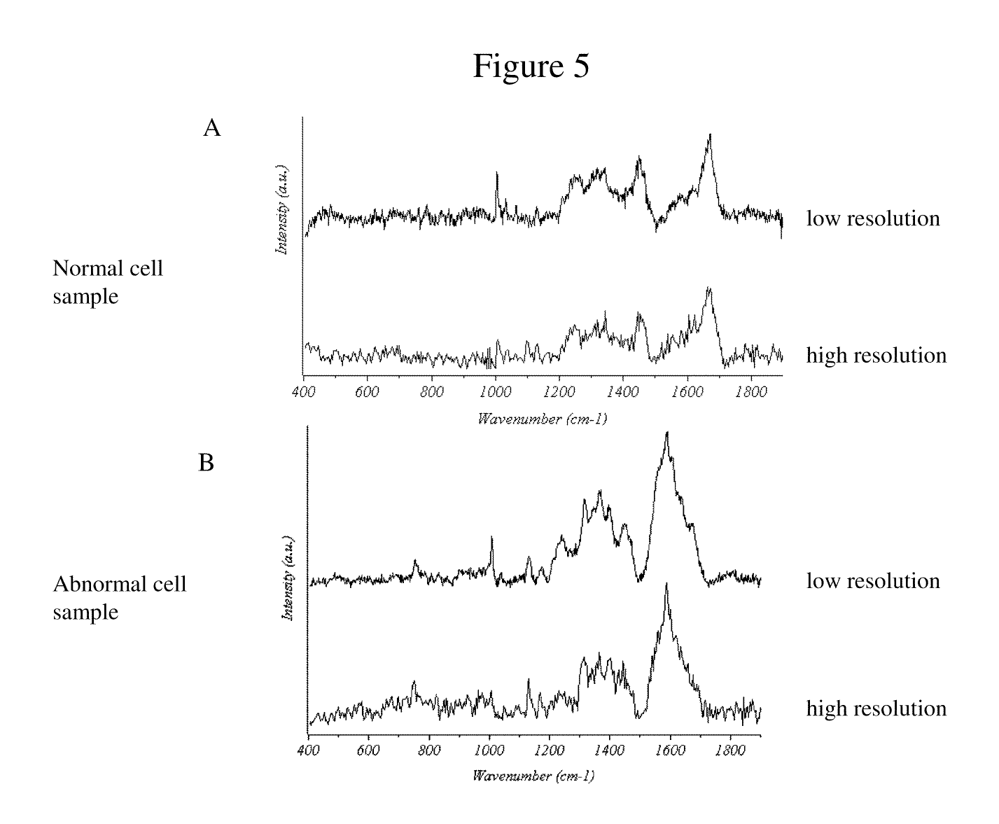

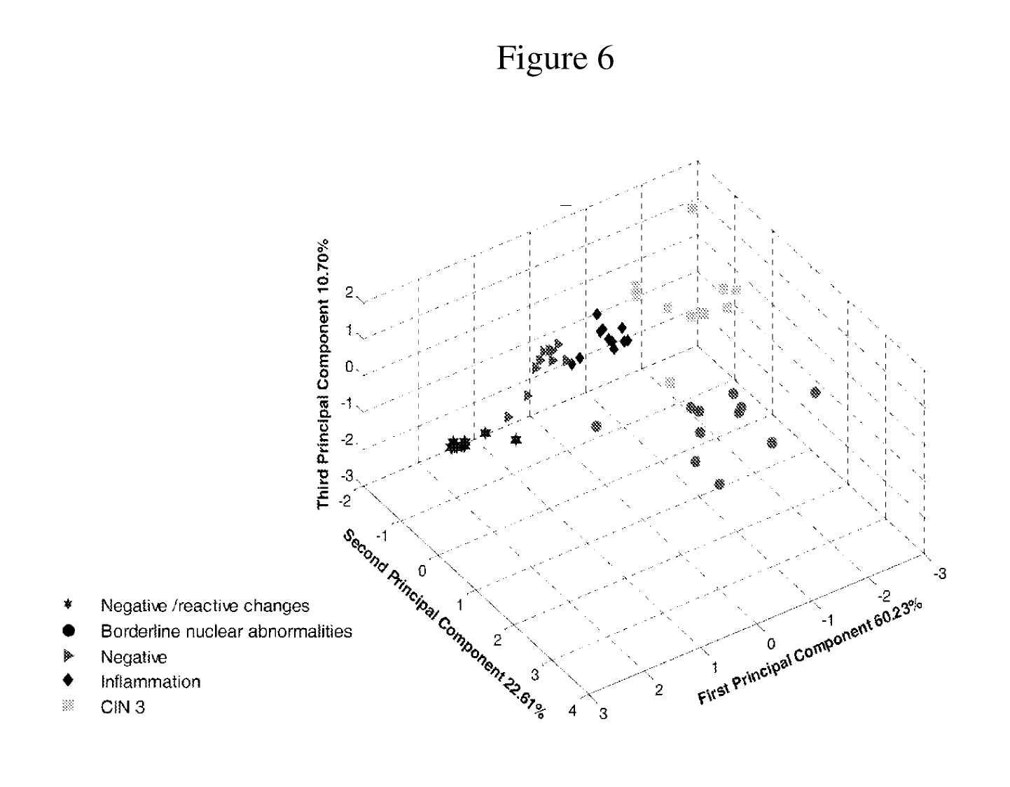

Raman spectra were acquired and subjected to data analysis, as described in Example 1. For the low resolution spectroscopy of the smear samples, a support vector machine (SVM) model was trained to allow automatic diagnosis of cells from smear samples. FIG. 5A shows Raman spectra for a normal cervical smear sample at low resolution (top) and high resolution (bottom). FIG. 5B shows Raman spectra for an abnormal cervical intraepithelial neoplasia (CIN) smear sample at low resolution (top) and high resolution (bottom). FIG. 6 is a principal component analysis (PCA) analysis showing discrimination among the different classes of patient samples (normal (negative), negative/reactive changes, inflammation, borderline nuclear abnormalities and CIN III smear samples).

Following rigorous model design and evaluation, the classification model was found to be 100% accurate on unseen data with 100% specificity and 100% sensitivity for normal and abnormal cell types.

### Example 4

### Cell Mass Consolidation

A mixed population of normal and abnormal cells (held in a liquid preservative) were consolidated into a solid mass by centrifugation at a speed of 1200 RPM for 8 minutes. The supernatant was then removed. The pellet was placed on a slide, and the slide was placed in the system described above in Examples 1 and 2. The pellet was aligned, and a representative spectrum for the pellet (rather than an individual cell) was obtained using low resolution Raman spectroscopy. The representative spectra was then compared with a library of reference spectra of abnormal cells, as described above in Examples 1 and 2. Approximately 30% of the cells were identified as abnormal.

1. A method for classifying a cell/tissue sample using Raman spectroscopy, comprising:
(a) performing Raman spectroscopy on a cell/tissue sample of unknown cell class and obtaining from the sample one or more low resolution sample spectra;
(b) comparing the one or more low resolution sample spectra to a reference dataset comprising spectral peaks associated with at least one cell class; and
(c) classifying the unknown cell/tissue sample as comprising one of the at least one cell class or not comprising the at least one cell class based on a determination of the similarity of spectral peaks of the one or more low resolution sample spectra and the spectral peaks in the reference dataset,
wherein the resolution of the one or more low resolution sample spectra is at least 3 wavenumbers.

2. The method of claim 1, wherein the unknown cell/tissue sample is gynecological, breast, urological, renal, digestive, thyroid, or lymph node cell/tissue.

3. The method of claim 2, wherein the gynecological tissue is vaginal, cervical, ovarian, or uterine tissue.

4. The method of claim 3, wherein the gynecological tissue is cervical tissue.

5. The method of claim 1, wherein the reference dataset comprises spectral peaks acquired from normal and abnormal cell/tissue samples.

6. The method of claim 5, wherein the spectral peaks acquired from the abnormal cell/tissue samples represent a premalignant cell class, a malignant cell class, or a combination thereof.

7. The method of claim 1, wherein the unknown cell/tissue sample is classified as normal or abnormal.

8. The method of claim 7, wherein the abnormal cell class is premalignant or malignant.

9. A method for classifying a cell/tissue sample using Raman spectroscopy, comprising:
(a) performing Raman spectroscopy on a cervical cell/tissue sample of unknown cell class and obtaining from the sample one or more low resolution sample spectra;
(b) comparing the one or more low resolution sample spectra to a reference dataset comprising spectral peaks associated with at least one cell class; and
(c) classifying the unknown cell/tissue sample as comprising one of the at least one cell class or not comprising the at least one cell class based on a determination of the similarity of spectral peaks of the one or more low resolution sample spectra and the spectral peaks in the reference dataset,
wherein the resolution of the one or more low resolution sample spectra is at least 3 wavenumbers.

10-16. (canceled)

17. A method for classifying a cell/tissue sample using Raman spectroscopy, comprising:
(a) generating from cell/tissue samples of at least one known cell class a reference dataset of low resolution Raman spectral peaks characteristic of the at least one known cell class;
(b) providing the reference dataset to facilitate comparing one or more low resolution sample spectra obtained from a cell/tissue sample of unknown cell class to the spectral peaks of the reference dataset and assigning the unknown cell/tissue sample to a cell class based on the comparison,
wherein the resolution of the spectral peaks in the reference dataset and the resolution of the sample spectra is at least 3 wavenumbers.

18-32. (canceled)

33. A method for classifying a cell/tissue sample using Raman spectroscopy, comprising:
(a) generating from cell/tissue samples of at least one known cell class a reference dataset of low resolution Raman spectral peaks characteristic of the at least one known cell class;
(b) generating a pattern recognition model/algorithm using the reference dataset of (a); and
(c) implementing the pattern recognition model to assign a cell class to an unknown cell/tissue sample based on one or more low resolution Raman spectra acquired from the unknown cell/tissue sample,
wherein the resolution of the spectral peaks in the reference dataset and the resolution of the sample spectra is at least 3 wavenumbers.

34-51. (canceled)

52. A Raman spectroscopy system, comprising:
(a) a low resolution Raman spectrometer having a spectral resolution of at least 3 wavenumbers; and
(b) an analysis module configured with a pattern recognition model/algorithm trained to compare one or more low resolution Raman sample spectrum acquired from cell/tissue sample of unknown cell class to spectral peaks of a reference dataset of Raman spectral peaks characteristic of at least one known cell class, and further configured to assign the cell/tissue sample to a cell class based on the comparison.

53-61. (canceled)

62. A software product comprising a computer readable file encoding a sequence of software instructions which, when executed, direct performance of a method of analyzing Raman spectra comprising:
comparing one or more low resolution sample spectra acquired from a cell/tissue sample of unknown cell class with a Raman spectrometer having a spectral resolution of at least 3 wavenumbers to spectral peaks of a reference dataset of Raman spectral peaks characteristic of at least one known cell class; and
assigning the test sample to a class based on the comparison.

63-64. (canceled)

65. A cytological method for analyzing a biological sample, the method comprising the steps of:
(a) consolidating a biological sample into a mass;
(b) obtaining a Raman spectrum for the mass; and
(c) comparing the Raman spectrum of the mass with one or more reference spectra, each of the reference spectra corresponding to a known abnormality to determine whether the contents of the mass contain one of the known abnormalities.

66. A cytology system for analyzing a biological sample on a sample holder, optionally a slide, the system comprising a stage for receiving the sample holder, a low resolution Raman spectroscopy device having a spectral resolution worse than 3 wavenumbers, the Raman spectroscopy device having an analysis module for determining whether the spectrum falls within one or more predefined classes of cell.
